(19) United States
(12) Patent Application Publication
(10) Pub. No.: US 2025/0373437 A1
(43) Pub. Date: Dec. 4, 2025

(54) TEMPLATE-LESS OBJECT RECOGNITION WITH CHALLENGE/RESPONSE PAIR MECHANISM

(71) Applicants: The Arizona Board of Regents on behalf of Northern Arizona University, Flagstaff, AZ (US); Brown University, Providence, RI (US)

(72) Inventors: Bertrand F. CAMBOU, Flagstaff, AZ (US); Saloni JAIN, Flagstaff, AZ (US); Amisha BAGRI, Flagstaff, AZ (US); Tuy NGUYEN, Flagstaff, AZ (US); Jeffrey HOFFSTEIN, Providence, RI (US)

(21) Appl. No.: 19/228,601

(22) Filed: Jun. 4, 2025

Related U.S. Application Data
(60) Provisional application No. 63/656,036, filed on Jun. 4, 2024.

(51) Int. Cl. H04L 9/32; H04L 9/08

(52) U.S. Cl. CPC H04L 9/3231; H04L 9/0869; H04L 9/3271

(57) ABSTRACT

An object recognition arrangement includes an enrollment process involving taking a biometric print of an object, which may be a biological object, generating a random seed, deriving challenges from the seed and using the challenges to measure the print resulting in a set of responses. A key is generated and used to encrypt a file. The key is then used to filter the response set, and a filtered subset is retained. Later, during a recognition process, another biometric print is taken of the object, the challenges are generated and applied to the new print, and a full set of responses are measured. The key is then recovered by comparing the full set of responses to the subset. The subset-superset response comparison may be done with multiple response streams, and the best stream is selected based on counting the number of a first binary symbol in the stream.

### CROSS-REFERENCE TO RELATED APPLICATIONS

The present application claims priority to U.S. Provisional Application 63/656,036 entitled “TEMPLATE-LESS OBJECT RECOGNITION WITH CHALLENGE/RESPONSE PAIR MECHANISM”, filed on Jun. 4, 2024, the entirety of which is incorporated herein by reference.

### STATEMENT REGARDING FEDERALLY SPONSORED RESEARCH

The invention described herein was supported by United States Government under grant number 1005387 awarded by U.S. Department of Defense. The Government has certain rights in the invention.

### BACKGROUND

Biometry and image recognition is a broad strategic field. In biometry (recognizing and categorizing biological objects such as human faces, retinal vasculature, finger prints, etc.), and more generally in image recognition, computers are tasked with making sense of their visual environment in a human-like way, i.e., to comprehend what is being sensed and to take appropriate action as a result. An important aspect of computer vision is the detection and classification of objects within an image or video stream. It is the goal of object recognition to enable machines to understand and interpret visual data. Applications for object recognition include autonomous vehicles (e.g., identifying pedestrians, vehicles, traffic signs and signals, etc.), robotics (e.g., manipulating and interacting with objects), healthcare (e.g., reading and interpreting x-rays), and surveillance (e.g., detection of intruders, targets and suspicious objects).

As a general matter, conventional image recognition systems and methods start with training the system on a known object template, which is then compared to contemporaneously sensed imaged data (i.e., image data sensed at some point after exposure to the known object). Such applications must overcome the challenge that the appearance of an object, or a person, can change with time due to, e.g., aging, weathering or damage. Additionally, the object's appearance will vary on the basis of scale (i.e., the size of the contemporaneously measured image on the system's optical detector), orientation, lighting conditions, and background. To overcome these problems and to improve accuracy, multidimensional identification of objects is typically recommended. Laser scanners are sometimes used for digitizing objects or humans for which the internal structure is irrelevant. To obtain a view of clean data points, the scanner generates the data that is then utilized in conjunction with software and/or an experienced operator to align the individual scans from each scanner's location. Alternatively, photogrammetry, through the use of photography and imaging, extracts accurate 3D information about objects and their surroundings from 2D images. Photogrammetry involves the science of making measurements to create maps, models, and representations of physical objects.

There is an increase in the use of object recognition and photogrammetry in people's everyday lives. As these technologies are progressively deployed in public spaces, sensitive environments and workplaces, privacy and data protection concerns are anticipated to arise. In particular, conventional systems are sensing and storing huge amounts of sensitive and identifying personal information about people who are observed by such systems, such as images of their faces, fingerprint scans, video showing their gait, etc. The persistent storage of such image data of a person's identifying physical features is disadvantageous because it may be leaked or stolen or otherwise used for nefarious purposes such as tracking or identity theft.

Additionally, there are ongoing challenges to the ability of conventional systems to use such information even for their intended purposes. Two-dimensional face recognition is sensitive to illumination changes and orientation changes in the subject. In 3-D face recognition, it has been observed that shape contains significant information about the identity and could eliminates the effect of illumination, which makes it possible to achieve high performance under different poses and illuminations.

For the purpose of 3-D acquisition and pre-processing, there are a number of techniques. In stereo acquisition, two or more cameras are positioned and calibrated to take continuous images of the subject. The other method is the structural light technique, where light pattern (e.g., a grid) is projected on the face of the subject, where distortion of the pattern reveals the depth information. This method is also fast, cheap, and uses single cameras. The laser sensor is more accurate as compared to the above methods but is expensive and slow. The 3-D information needs to be processed. Depending on the 3-D sensor used, there are holes and spikes that must be filled. For example, the eyes do not reflect the light properly.

As stated above, most conventional object or human recognition systems rely on a first measurement of the object in a controlled environment to generate and store information that will be compared to future image data, which will typically be gathered in less controlled circumstances. This initial step of gathering image data is referred to as registration. In the registration phase, most conventional algorithms start by aligning the face (i.e., controlling the angle and x-y-z position of the face relative to the look-axes of the optical sensor(s)), which can be done by using the face's center of mass, nose tip, eyes, or by fitting a plane to the face and aligning it to the camera. There are various examples of data points extracted from facial image data to characterize the face (e.g., to build a template that can be compared to future data). Examples of methods used for face representation include the following:

Landmark-based face representations. Landmarks are defined as precise locations on biological forms that hold some structural or evolutionary significance and are extensively used in morphometrics. This does not require high computing power.

Curve-based face representation, which uses facial curves such as outline and profiles of the facial surface, which can be extracted. This method may be used where there is only a small amount of landmark information—typically when landmarks are too difficult to define or locate.

Complete surface-based representation. This strategy aims to retain as much of the entire facial surface as possible. However, this technique requires sophisticated equipment for data acquisition and a complex algorithm for data processing and registration.

Registration is important for similarity matrices. Iterative Closet Point Algorithm (ICP) is a registration technique. Before the data extraction, alignment between two faces is performed. Faces are adjusted to have the same orientation and the same location in 3-D space. After alignment, the 3-D locations on corresponding points on the facial surface are extracted.

For facial recognition techniques, one of the first techniques used is the based method which highlights the importance of surface features particularly surface normal at various points on the face. However, this technique is sensitive to noise and requires smoothing and pre-processing techniques. Another technique used is Statistical Shape Analysis which involves a geometrical analysis of a set of shapes and statistics to describe common geometrical properties. Linear Discriminant Analysis (LDA) is an example of a statistical method extracting discriminative features from different representations. With the point cloud representation, ICP is used for registration. It calculates the similarity between two points for each iteration. It has an average accuracy of 96.48±2.02.

The challenges in measuring biological objects contemporaneously with sufficient accuracy to match the object to a previously measured object are even more pronounced when dealing with aerial detection systems (e.g., detection systems where the optical sensors are in flight). In these systems, the noise and environmental variances of the contemporaneous image data are at very high levels due to differences in lighting angle, clouds and dust, distance to the target, and motion of the camera platform, for example. Thus, performing accurate biological object detection and recognition in these scenarios requires overcoming at least two problems: 1) the sensor platform used for real-time recognition can be a camera mounted to a drone, aircraft, satellite, etc., where the flight positioning is affected by the vertical and horizontal angles which influence the quality of data captured; and 2) the media captured by the aerial platform must be transmitted in real time or close to real time with satisfactory quality. These conditions have a direct influence on the quality of the data used for face detection and recognition, and conventional systems have great difficulty in performing real-world biological object recognition under these conditions.

Fundamentally, objection recognition techniques require the ability to extract identifying data from an object (or things like an accurate image of the object), and then use of that data to determine that an object (or image of the object) sensed at a later time has been generated by the same object. This is a similar process to that used when physical unclonable functions (PUFs) are used for cryptography and authentication. A PUF may be thought of as a physical object, or some collection of objects, that may be used as a one-way function (i.e., a function that produces a consistent, repeatable output from a given input, but where the output not usable to derive the input that produced it). The salient and defining features of a PUF are uniqueness (there is only one PUF), repeatability, and one-wayness. It has been observed that physical objects, including biological objects, have the characteristics of conventional PUFs. A human's face is unique and may be measured in a way that produces repeatable results that are unpredictable without possession of the face or measurement data from the face.

In practice, PUFs are used as challenge-response-pair (CRP) generation mechanisms. A set of challenges is generated, which may things like addresses of individual devices in the PUF or PUF array to be measured, and/or measurement conditions for measurements. The challenges are applied to the PUF (e.g., the device or devices are measured), and some response set is measured and stored. A different device may then generate the same challenges, apply them to a copy of the PUF or an image of the PUF, and generate the same responses. The responses may be used as tokens, or tokens may be derived from the responses, that can be compared to conclude that both devices are in possession of the same PUF (or the image). Various PUFs and methods of using them are described in the patents and applications listed below, however, it will be recognized that physical objects, including biological objects, may be used in the same manner as PUFs. In the imaging context, a set of measurement conditions (challenges) may be generated (e.g., locations on a human face to be imaged or otherwise measured). The challenges may be applied (i.e., the face may be measured at various points, and the data recorded) to generate responses. And the responses may be used in some manner.

U.S. Pat. No. 10,503,890, entitled “Authentication of Images Extracted from Unclonable Objects,” filed as Ser. No. 15/434,967 on Feb. 16, 2017, and published as 2017/0235938 on Aug. 17, 2017, describes how an unclonable and unique physical object, which may be a biological object, can be used for authentication using a CRP mechanism quite similar to the way physical unclonable functions (PUFs) operate. That patent and publication are incorporated herein by reference in their entirety. According to that disclosure, the responses generated from the image of the unclonable object are then compared with the responses generated from the image kept as references. The CRP mechanism described in that publication is usable with any image of an unclonable object, including biological objects, such as images of human faces, irises, retinal vasculature and fingerprints.

U.S. Patent Publication Number US20240348436A1, entitled “Biometry with challenge response pair mechanism”, filed as Ser. No. U.S. Ser. No. 18/638,412 on Dec. 27, 2023, includes additional disclosure regarding how biological objects and their images may be used as a CRP mechanism, similar to PUFs. The disclosure of this application is incorporated herein by reference in its entirety for all purposes. This application discloses systems and methods to replace or augment image recognition techniques with challenge-response-pair (CRP) mechanisms for secure key generation and exchange, while never storing any personal biometric information. The input parameters, the “challenges”, are instructions generated from random numbers, while the output parameter, the “responses” are generated from the challenges with CRP mechanisms applied to unclonable physical objects, such as PUFs or biological objects, or data representations thereof such as biometric images. The disclosed protocols incorporate sequences of n challenges, which generate, through biometric-based CRP mechanisms, sequences of n responses. Described are several variations of key exchange protocols that are based on comparing the original sequences of responses resulting from CRP mechanisms with sequences of responses that are modified by the keys that are exchanged.

Additional methods have been suggested of using biological objects and biometric prints (i.e., measurement data of biological objects) as CRP generators to generate cryptographic keys. In these systems, security is enhanced because, rather than storing a key for authentication, it is enough to store the challenges and to have access to the physical object (or print) that generates the responses. The responses are the keys, and they are recovered through the biometric images and their challenges. One such system is disclosed in U.S. Patent Publication Number US20240214224A, entitled “Pseudo-homomorphic Authentication of Users with Biometry”, filed as U.S. patent application Ser. No. 18/397,975 on Dec. 27, 2023. This publication is incorporated in its entirety herein for all purposes. In the system therein described, biometric prints (e.g., physical measurement data such as processed or unprocessed image data of finger prints, palms, facial features, retinal vasculature and other vein patterns, iris appearance, and/or image data regarding any of the aforementioned, combinations thereof, and/or image data regarding body gait or infrared images of body parts) are used as CRP generation mechanisms.

Other background relevant disclosure can be found in U.S. Patent Application No. US20250023736A1, entitled “Protocols with noisy response-based cryptographic subkeys”, filed on Apr. 17, 20024 as Application Ser. No. U.S. Ser. No. 18/638,593. The entirety of this publication is incorporated herein by reference for all purposes.

In the disclosures referenced above, generally speaking, some information is extracted from a biological object (or a print or image of a biological object). This may occur under controlled measurement conditions. The information extraction process occurs through a measurement process, which is preceded by challenge generation (i.e., a set of measurement instructions). The extracted information (i.e., the responses) is then used in some way as a token representing the object. The responses, or some information derived from the responses, may be used for cryptographic key generation, or may be compared with future measured responses to authenticate a user or the object itself. While these protocols allow for object recognition without storing a large amount of information about the object, they may be further improved.

The novel schemes can re-use or be combined with a large range of known and commercially available methods to generate multiple images from a tri-dimensional object include, not to be limited to, photogrammetry, image processing, and artificial intelligence.

### BRIEF SUMMARY

In certain embodiments, a computerized arrangement and method is disclosed for recognizing previously enrolled objects, which may include biological objects such as human faces, fingerprints, etc. In the preferred embodiments, a biological object is subject to an enrollment process where it is visually characterized, i.e., imaged. In preferred arrangements, the object is enrolled at a first device, which may be referred to below as a “server”. In certain cases, the image data of the object is taken with a camera from a first angle (e.g., with the camera's look axis or optical axis aligned to a predetermined surface normal of some point on the object). Additionally, in certain cases, the image data of the object is taken with the object at a predetermined scale, that is, at a predetermined distance and/or magnification, such that the size of the image of the object formed by the camera's optical imaging system is a predetermined size. In other embodiments, multiple images of the object are taken at the server at a plurality of angles and scales.

The object is recognized during a second process, which is a recognition process. The recognition process will be generally described below as occurring on a second computing device, which will be referred to as a “client” or a “terminal device”, but this is not a requirement. The methods to be described may also be employed on a single computing device that first runs an enrollment process, and later runs the recognition process. Additionally, a terminal device (e.g., a remote camera, UAV, etc.), may collect contemporaneous image data, and electronically transmit that data to a server device to perform the recognition process. In other cases, the terminal device may perform the recognition process itself.

In certain embodiments, to begin an enrollment process, the server generates a first random seed number, which is a bitstream. Preferably this seed is a random number. The seed is segmented into challenges, that is, it is divided into segments, and each segment is read or interpreted to provide instructions (challenges) for measuring or querying the stored image data to reveal some data in the image. For example, at the server, the image data may be fit to a 2-D coordinate system, and facial features (e.g., pupillary centers, the interpupil midpoint, eye corners, nose tip, mouth corners, etc.). A lookup table may be built at the server that stores a variety of data regarding these features, such as their x-y coordinates in the 2-D grid and a unique binary index value for each feature or landmark. Then, each challenge (segment of the random seed) may be read to identify an x-y grid coordinate, and a facial feature. The challenge instructions are applied to the image data in some way (e.g., by measuring a distance or an angle from the coordinate specified by the challenge and the facial landmark identified by the challenge). The result of applying the challenge instructions to the image data is a set of responses. As part of this response generation process, it may be determined that certain of the challenges generate noisy responses (e.g., if a facial landmark is next to a scar or some other unique feature that introduces measurement error), and challenges that generate noisy responses may be noted and masks constructed to exclude those responses and challenges from the data used. Challenges that generate the same response (i.e., collisions) may also be masked.

The server may then generate a token of some sort from the responses. In one embodiment, this may be done by generating (again, preferably randomly) an encryption key, which is another binary bitstream. The encryption key will be a bitstream having the same number of responses (which will generally be equal to the number of challenges) used in the method. As it is random, and as it chosen to be sufficiently large (e.g., 256 bits), it will have about an equal number of 1s and 0s. The bits of the key are then used to filter the response set. A subset of responses is built, where each enrollment response that has the same position as a 1 in the key is kept. This subset of responses may be used to reconstruct the key later during a recognition cycle, but some method must generally be used to determine that the later-generated responses (the recognition cycle responses) were generated by the same image data as the enrollment responses, only a subset of which was retained. One method of making this comparison is for the server, during enrollment, to create some token with the encryption key. For example, in some embodiments, the server encrypts a plaintext file with the encryption key. The key is then deleted. If the enrollment responses can be used to recover the encryption key during the recognition process, and the ciphertext decrypted and read, this will effectively match the recognition responses and the enrollment responses.

After enrollment, the image data and the key may be deleted, which enhances security. The only information that must be retained is information necessary to re-generate the full set of challenges (e.g., the first seed and mask data, if used), the full response set and the encrypted file or other token that will be used to judge comparison between the enrollment responses and the recognition responses.

Later, during a recognition cycle, new image data is taken of the same object. This may be one or more images of the same biological object that was used during enrollment. The challenges are re-generated from the seed. Bad challenges are optionally masked using the masking data. The challenges are applied to image date to generate an ordered full set of responses from the image data taken during recognition. There may be multiple ordered full sets of responses corresponding to multiple images, in certain embodiments. Each response in the full set of responses is then compared, on an individual response by response basis, with each of the retained enrollment responses. The matching criteria may be an exact match, but preferably, is a match above some threshold (i.e., a match within some bad-bit threshold or Hamming distance). The goal of this is to rebuild the encryption key. Where there is a match between a recognition response and an enrollment response, the key is assigned a “1” at the position of the matching enrollment responses in the ordered set of responses. Where there is no match, a zero is assigned. With the key rebuilt, the recognition process uses the key to decrypt the encrypted file. If the decrypted file is readable as clear plaintext, the recognition process knows that it received the same responses that were generated during enrollment. This is the equivalent to authenticating the image—a conclusion that the same biological object generated both the enrollment responses and the recognition responses.

As stated above, the recognition process may be done by the same server device at which the enrollment is performed, or it may be done by a remote client device (i.e., a terminal device). In cases where a client device is used, the client device can receive and store the full response set, the seed to generate the challenges, and the encrypted file. In these embodiments, there is no need for any device to share or transmit image data, which is advantageous for security concerns. Additionally, this arrangement permits the terminal device to recognize the object autonomously, without further communication with the server device. In other embodiments, however, the server device conducts both processes. In other embodiments, a terminal device may transmit image data to the server device, which then performs the recognition.

As noted above, a difficulty arises when the terminal device takes the recognition image data under a different set of measurement conditions than were used to generate the enrollment image data. The enrollment data is preferably taken under a controlled set of conditions (e.g., the individual subject is directly face on to the camera and the image magnification is set to make ideal use of the camera's detector's pixel resolution). In some cases, however, the enrollment data may be taken from a photograph, which might be the case if a party using the arrangement is trying to locate an individual, for example, on a battlefield or for law enforcement purposes and does not have access to the individual. Additionally, in many circumstances, the recognition data will be taken under non-ideal circumstances (e.g., from an aerial platform, which is moving, and which is far away). This is likely to result in an image taken that is not scaled and is not angularly consistent with the enrollment image (e.g., is tilted about the optical axis with respect to the optical axis). Certain of the embodiments described below deal with challenge by searching through multiple sets of recognition image data to find the best match to the enrollment image data. In other embodiments, a single or small set of recognition image data searched to find the best match with multiple sets of image data that were taken during enrollment (referred to below as “comprehensive enrollment”).

Certain inventive embodiments rely on the recognition that the best fit set of responses may be determined by selecting the response set that encodes the highest number of is in the recovered key. Recall that the key is a randomly generated binary number, and so will have approximately 50% is and 50% 0s. Thus, the best response set will be the set that matches to about 50% of the responses in the enrollment first response set. Because there will generally be residual matching errors introduced by differences in measurement conditions, a perfect match, indicated by ˜50% of the recovered key being is as determined by response matching. Thus, in certain embodiments, a matching threshold is established (e.g., 50, 60, 70, 75, 80, 90%, or some number between any of these numbers, of the expected number of Is), and a best fit is determined if the number of is in the recovered key exceeds the threshold. For example, suppose the key is 256 bits long. The expected number of is (and the expected number of matching responses) is half of 256 or 128. A threshold may be set (e.g., 100, which is 78% of 128), and the response set that generates 100 or more matches is used to generate the key. Residual errors in the key may be addressed by iteratively flipping zeros, and using the key to attempt to decrypt the file until the file is readable. Similar key repair and error correction methods are disclosed in U.S. Patent Publication No. US20240214224A1 entitled “Pseudo-homomorphic authentication of users with biometry”, filed as application Ser. No. 18/397,975 on Dec. 27, 2023, which is incorporated herein by reference in its entirety. The methods disclosed in the publication referenced immediately above may be used to deal with residual errors in the key.

Thus, the keys just described are generated using a challenge-response-pair (CRP) generation mechanism. The CRP mechanisms are analogous to conventional physical unclonable functions (PUFs), which are used as a black-box CRP mechanism. In certain of the arrangements described below a biological or biometric print is used as the CRP mechanism. A biometric print is a set of data accurately reflecting an unclonable biological object. An example of a biometric print would include a processed or unprocessed digital image of a biological object, such as an individual's face, fingerprints, irises, retinal vasculature, etc., but this is not limiting. The methods and arrangements described below for using image data as a CRP mechanism may also apply to other unclonable physical objects. A biometric print, in some cases, may also include information about the measurement conditions of generation of the print, such as time and date, illumination conditions (e.g., average radiance or irradiance of the object that generated the print), magnification, illumination spectrum, and geometrical information, such as the position and scale of features in the print relative to some reference axis.

In embodiments described below, a biological object (i.e., a human face) and a biological print of the object (e.g., an image of a human face) are used as a PUF. In an initial phase, the PUF is read multiple times to identify the consistency within it, and the image is saved at a first computing device (i.e., a “server”). During a key generation step, the server generates a set of random instructions, which will be referred to herein as challenges. These are sent to the PUF for processing (that is, they are used to extract information from the image). This image of the PUF then produces a unique response generating cryptographic keys. In an authentication phase, the same set of challenges are recovered and are used to extract information from the physical PUF, which is at the client. As a result of comparing the responses received from the client with the responses initially received on the server side, any small differences are identified and corrected using error correction schemes. The methods described in this disclosure use three-dimensional (3-D) images generated by multiple photographs and images obtained through photogrammetry as a PUF to authenticate the object identification process. The technology can be used to identify individuals at an airport, in public spaces, etc., as well as to identify objects in a particular area. This method ensures security by not storing the images, as well as providing a secure identification process that can be used in a variety of applications.

### BRIEF DESCRIPTION OF THE DRAWINGS

The drawings described herein constitute part of this specification and includes exemplary embodiments of the present invention which may be embodied in various forms. It is to be understood that in some instances, various aspects of the invention may be shown exaggerated or enlarged to facilitate an understanding of the invention. Therefore, drawings may not be to scale.

FIG. 1 depicts a linear search wherein the orientation of the object to recognize is known along the vector (X₀, Y₀, Z₀).

FIG. 2 depicts a 2-dimensional (2-D) search which is a planar search wherein Z₀=0, and the distance do of the object to recognize is also known.

FIG. 3 depicts a 3-dimensional (3-D) search wherein the orientation of the object to recognize is known along the vector de (X_{f}, Y_{g}, Zₕ).

FIG. 4 depicts fingerprint authentication using feature matching wherein fingerprint features are extracted using OpenCV, and the extracted features are to be used to create CRPs for future authentication without storing fingerprint image.

FIG. 5 depicts key generation using image features and benchmarks-based CRP mechanism wherein object features/benchmarks using existing image recognition/detection methods re extracted, keys based on CRP mechanism are generated, and generated keys are to be used in post-quantum cryptography algorithms.

### DETAILED DESCRIPTION

The described features, advantages, and characteristics may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments.

Reference throughout this specification to “one embodiment,” “an embodiment,” or similar language means that a particular feature, structure, or characteristic described in connection with the embodiment is included in at least one embodiment. Thus, appearances of the phrase “in one embodiment,” “in an embodiment,” and similar language throughout this specification may, but do not necessarily, all refer to the same embodiment.

It is contemplated that, in preferred embodiments, the methods described below will be carried out in a computing environment including at least one computing device, and in some cases, two computing devices in electronic communication with one another. The first device will be referred to as a “server” or a “central” device, and the second device will be referred to as a “client” or a “terminal” device. References to “users” refer generally to individuals accessing a particular computing device or resource, to an external computing device accessing a particular computing device or resource, or to various processes executing in any combination of hardware, software, or firmware that access a particular computing device or resource. Both the client and server devices are, preferably, general purpose computing devices, which may include non-volatile storage, a programmable processor, input/output devices, and network interface devices. The non-volatile storage may encode computer readable instructions that, when executed, cause the processors in the server and client devices to execute the method steps described throughout this disclosure.

The server and client devices discussed below preferably also include circuitry and electronic instruments necessary to measure a physical characteristic of some physical object, such as a PUF, or preferably, a biological object (such as a human face) and to generate responses from the resulting measurements. An optical image capture device such as a camera (having an optical imaging system, a 2-D detector and, optionally, illumination optics such as LEDs) is one example of such an electronic instrument. Other examples would include multiple camera arrays, LIDAR or other laser scanners, sonar scanners, RF scanners, microscopes with attached cameras, and 2-D or 1-D flatbed scanners for taking image data of a fingerprint. In certain cases, the client device may be a smart phone including a camera. In certain cases, the central and terminal devices may be processes running on the same device.

In the examples that follow, a biological object, unique to a human individual, is used as the foundational element for CRP generation, however the inventive embodiments are not so limited. It should be understood that the methods described herein apply to any CRP generation mechanism based on any unclonable physical object. For example, other physical objects may also be used as a CRP mechanism. For example, image data may be taken and measured of biological objects from non-human subjects, or from non-biological natural objects, the appearance of which, demonstrates sufficient randomness and complexity. For example, U.S. patent application Ser. No. 15/434,976, published as 20170235938 on Dec. 10, 2019, describes taking image data of DNA or nanoparticles and then measuring those images as a CRP mechanism. That application is incorporated by reference herein in its entirety

In the examples that follow, a biological object, unique to an individual, is used as an unclonable function, capable of generating unique and repeatable responses when measured according to certain measurement parameters (challenges). In practice, the biological object is some feature of an individual user's body (e.g., a fingerprint, iris, retina, facial features, etc.). The challenges are instructions that specify a particular set of biological object measurement conditions. For example, a challenge might be a location on an image of a fingerprint, and an area at that location to be measured. The responses might be features (variations in color or shade or shape, intersection of lines, etc.) measured at the specified area or areas, or along a specified direction. In some embodiments, a biological object may be subject to a pre-enrollment setup state to generate calibration data that is used to standardize all future image data taken from the object. This enables future measurements of the same object to perform under the same conditions as prior measurements. In the case of taking image data from the object, the pre-enrollment data may enable the system to rotate and scale future images to a baseline orientation and scale before each response measurement such that all measurements of the same features are as repeatable as possible. This same calibration and scaling methodology may be applied to any of the protocols described below, which all involve measuring a first set of enrollment responses from a biological object, and comparing those responses to a second set of responses from the same biological object measured at a different time in the future. These two measurements have to be compatible, so inventive embodiments are capable of rotating and scaling images, and calibration data may be stored to accomplish this.

The use of a biological print to authenticate a user, which may be extended to image recognition, will now be described to provide context for the improved methods to be described below. As stated above, a biological or biometric print is some accurate data representation of the biological object, e.g., processed or unprocessed image data of finger prints, palms, facial features, retinal vasculature and other vein patterns, iris appearance, combinations thereof, image data regarding body gait or infrared images of body parts. In the example now described, a human face is used as the CRP generation mechanism.

An enrollment procedure is conducted in a secure environment. The enrollment procedure begins with the generation of a first ordered sequence of n random seed numbers. In the exemplary methods described below, input parameters, “challenges”, which are measurement conditions for the biological object, in this case a face, are generated from random seeds. These seeds are shared by the client and the server and used by both to generate n challenges: C1, C2, . . . ,Cn. These challenges are functions that operate on information generated from biometric images, in a manner similar to that of a one-way function to produce outputs. In the exemplary cases described below, a user individual presents an image of her face by looking into a camera. This image is transformed into a vector v (i.e., a biometric print) upon which the challenge functions Ci operate, producing an ordered sequence of n responses: R1, R2, . . . ,Rn, with each Ri=Ci (v). The challenge functions have the following properties. In a manner similar to a one-way function, it should a very hard problem to map back from the responses Ri and obtain any information about the biometric information v. Also, different responses Ri, Rj with i not equal to j, arising from different randomly generated Ci, Cj, should be completely independent of each other. However, if the identical challenges Ci are applied to a slightly different vector v′ arising from a very similar image of the same person, the responses R′i=Ci(v′) should be very close to each other. This behavior is quite different from a standard hash function, where even one bit of difference in the input should create an entirely different output. To summarize, a vector of n functions of slightly different images of the same face: (R′1, R′2, . . . ,R′n) should be very close to the original vector (R1, R2, . . . ,Rn) when the same collection of challenges C1, C2, . . . ,Cn is applied to the two vectors v and v′ generated by the same client. One way of thinking about this is that a collection of different images of the same client should map to n-dimensional vectors inside a sphere of small radius in n-dimensional space. However, a different client should produce a vector w of biometric information whose corresponding vector of responses under the same challenges: (C1(w), C2(w), . . . , Cn(w)) is as distant as possible from the sphere containing (C1(v), C2(v), . . . , Cn(v)). The methods described below achieve this balance, that is, mapping similar images of one client to a small sphere, and mapping images of a different person to a discernably different position in space, is achieved, which greatly enhances the usability and security of the described protocols.

U.S. Patent Publication Number 2024/0348436 (referenced above) contains additional detail on how a biological print of a biological object such as a face may be challenged using a series of challenges parsed from a first random seed. A simple example will now be described.

Suppose the biological object is a human face, and the biometric print being measured is an image of the face. An image of a human face contains identifiable landmarks such as the bridge of the nose, the tip of the nose, pupils, etc. These landmarks are preferably identified in a pre-enrollment process, and calibration data is stored to rotate and orient future images of the same face to a standard x-y coordinate system, and to scale future images to a standard scale. An example of this process would be to define a line connecting the center of pupils as the X axis of a reference coordinate system, and to scale the facial images such that the interpupillary distance for all images is a set amount in the coordinate system. This enables all images of the same face to be compared accurately.

According to the basic method, a first random seed number S is generated by a random number generator (RNG) or pseudo random number generator process at a programmable processor at the server, which is directing the enrollment process. This seed Should be parsed into an ordered series of n segments each segment of m bits. Each segment may be read to provide challenge instructions that are applied to the image of the face to elicit responses. An example regarding how to do this would be to read each segment of S as identifying a starting X-Y coordinate in the system to which the facial image is mapped, and a facial feature (e.g., −3, −4, center of left pupil). Random numbers (e.g., the seeds discussed above) may be parsed to render coordinates in a straightforward manner, and it is contemplated that a lookup table may be constructed that maps numbers to facial features. Thus, a random number like 11001010 may be decomposed into a first portion that maps to a first coordinate, a second portion that maps to a second coordinate, and third portion that maps to a facial feature through a predetermined lookup table. In this way, challenges may be constructed of random numbers, or random numbers expanded to certain lengths and/or hashed with passwords as discussed above. The responses are the results of applying these challenges. An exemplary response would be a scalar distance value (e.g., the distance in the coordinate system from (−3, −4) to the center of the left pupil. Angle information may also be incorporated, e.g., the distance and angle to a feature from the challenge coordinate. It will be recognized that this sort of use of biological features as a CRP mechanism may be extended to other objects that have recognizable landmarks, such as irises, retinas, fingerprints and palm prints, all of which are within the scope of this invention as biological objects form which biometric prints may be generated.

The seed S or information from which the seed may be derived is shared with or otherwise also in possession of the client device. Later, after enrollment, the client device may take another image of the face, generate the same challenges, and apply the challenges to the image to generate the responses. For the server to authenticate the client, or the devices to generate a matching cryptographic key pair, it must be determined that the server generated the same response set as the client. One way to do this is for one device (e.g., the client) to use a RNG or PRNG to generate a second random number, key K having n bits (where n is the number of segments of S, i.e., the number of challenges and responses). The client is in possession of an ordered set of n responses (corresponding to the n challenges read from the seed S). The client may select the responses that have the positions in the ordered sequence of responses that correspond to is in K. That subset of responses can be sent to the server, which has its one complete ordered sequence of responses (or it may measure new ones from a stored copy of the biometric print with S). The server can generate K by comparing the received subset of responses (which correspond to is in K) with its own complete set in a piecewise fashion to determine which received responses match responses in the complete set. For matching responses, the server puts a “1” in its copy of the key, and for responses in the server's complete set of responses for which no matching response is received from the client, the value of K is a “0”. Either device can then compare the pair of generated keys to determine that the same face generated each set of responses.

The embodiments below are directed to extensions of this idea for image recognition. In the image recognition case, in certain cases, there will be a single machine that is in possession of the CRP mechanism (e.g., the seed, a biological print taken during enrollment, the initially measured responses themselves, etc.). That computing device may receive a second biological print (e.g., a facial photograph) and will then generate new responses with the seed-generated challenges on that second print to generate new responses, which can then be compared in some way to match the photograph to the initially enrolled photograph. In some cases, a second computing device (e.g., a UAV with a camera and its own computer occupying the role of client) will be transmitting data (i.e., the response subset) to the first (server) computer, such that the server can match responses in the manner set forth above. In yet other cases, the remote or terminal device acts as a client device, and will generate the responses and perform matching (or equivalent operations) itself.

In many image recognition applications, the contemporaneously taken image will be taken under much different conditions than the enrollment image or images. The object will be photographed or filmed while it is moving, or from far away, or from a moving camera platform, or under different lighting conditions, etc. This noise in the later taken image will cause a higher response mismatch rate than will typically the case when a person is looking into a camera, straight on, at an ATM machine, etc. The embodiments described below are intended to deal with this challenge.

In a first protocol presented in this disclosure, an image of a physical object (referred to elsewhere more generally as a biological or biometric print) is taken at a server device using a camera system during an enrollment cycle. During a recognition cycle, which may be initiated by a client device with its own camera or cameras, may also be performed by the enrolling device with its camera(s), multiple images of the object under different orientations are taken. In a second protocol, the opposite process flow occurs: various images under different orientations are generated during the enrollment cycle, and a single image is generated during the recognition cycle. In both cases, the system attempts to find responses corresponding to images that have the same or close orientations and scales during the enrollment and recognition cycles.

Generally, under both protocols, there may be an optional pre-enrollment cycle, where one or more biological prints are taken of a biological object, and these prints are analyzed to generate calibration data, which may be stored at a server. The calibration data may include data sufficient to orient future images of the object to a reference axis (e.g., identification of pupils and measurement of interpupillary distance). The calibration data may also include data identifying features in the image that are consistent between images (i.e., that are not the result of noise introduced in the print taking process).

The protocols next incorporate an enrollment cycle, which may occur at a server device. During the enrollment cycle, two data streams are randomly generated at the server, as in the methods described above. A first stream S, is a stream from which the challenges are derived. S is kept for future recognition cycles, and may be sent to client device if it is being used. The second stream K is a stream from which a secret ephemeral key of bitlength n is derived, which is erased after enrollment. The stream S is segmented into an ordered sequence of segments n, each of which is read as a challenge instruction (i.e., a measurement location, a measurement type, or other measurement instructions to be used to measure the stored image). The challenges are applied to the challenge/response pair (CRP) mechanism (i.e., the image data), to generate an ordered set of n responses (one per challenge) from the image(s) of the object during both enrollment and recognition cycles. During enrollment, the ephemeral key is used to filter the sets of responses to generate subsets of responses that are also kept for future recognition cycles. The responses located at a first binary value (e.g., a state of “1”) of the ephemeral key are kept, while the responses located at the second binary value (e.g., a state of “0”) are erased. Therefore, if the ephemeral key is 256-bit long, the number of responses kept in the subset is on average equal to 128. During recognition, the subsets of responses allow the recovery of the ephemeral key with newly generated responses. If the image used during the recognition cycle is similar to the one used during enrollment, the key recovered from the subset of responses has on average 128 states of “1”, which corresponds to 128 matches between newly generated responses (during recognition) and previously generated response (during enrollment). When this occurs, the recognition is judged positive. Conversely, if number of “1”s is too low, the image recognition is judged negative.

Most existing image recognition methods quantify the levels of matching by measuring the error rates which should be lower than a given threshold. By contrast, the novel protocols described herein directly quantify the levels of matching of the images by measuring the number of “1”s, i.e., NSk_{(e,f,g,h)}, during the recovery of the ephemeral keys. The threshold selected to match the subset of responses with the full set of responses is adjusted above the natural collision rate of independently generated responses, such as 75%. For example, if a 256-bit long key has 128 “1”s, the recovery of 100 “1”s is only happening when 100 responses are matching with error rates below 25%, which suggests that the recognition cycle was most likely positive. The image recognition cycle is a two-step process: the reference image located at the position pointed by vector

$$V ( {d}_{0} , {f}_{0} , {g}_{0} , {h}_{0} ) = {d}_{0} ( \begin{matrix}{x}_{0} \\ {y}_{0} \\ {z}_{0}\end{matrix} ) ,$$

and the vector

$$V ( e , f , g , h ) = {d}_{e} ( \begin{matrix}{x}_{f} \\ {y}_{g} \\ {z}_{h}\end{matrix} )$$

should match; then the number of “1”s NSk(e, f, g, h) of the key recovered in this position should be high enough.

### Linear Search

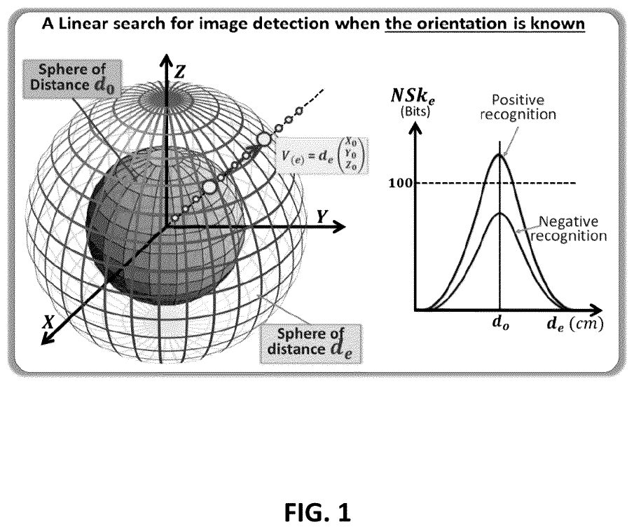

Referring now to FIG. 1, that figure depicts a linear search for a feature in object image data. The first objective is to find the distance of the observation d0 of the object. The number of “1”s NSKe at the distance de quantifies the levels of matching. The recognition cycle is judged as positive if NSK0 is greater than 100 (˜80% of expected response matches) at its optimal position d0. An example of effective linear search is when the orientation of the object is known during recognition cycle with the unknown parameter being the distance of observation dₑ or some other parameter or set of parameters impacting the scale of the object on the camera's detector. Such a situation can occur when the type of object to recognize is known, which is often the case for image recognition. For example, in biometry, methods aligning the facial image of a person using the shape of the head and the position of the two eyes are widely used; a linear search is then likely to yield a successful facial image recognition cycle in which the distance dₑ varies. The graphical representation of the linear search is shown in FIG. 1. The number of matching “1”s NSkₑ of the key recovered at the distance of observation dₑ is plotted in the graph shown in the right side of this figure. In practical terms, the distance of observation can vary by changing the magnification of the camera involved in the recognition cycle. NSkₑ=0 is at its peak when the distance dₑ matches the distance d₀ used during enrollment, even with the wrong object/person. When NSkₑ=0 is high enough, the image recognition cycle is considered as positive. When the key is 256-bit long, an average NSkₑ=0 of 128 bits is expected during recovery; however, with values greater than 100, the probability that the right key was recovered is high. At this point, the noisy keys can be corrected by using the method described in U.S. patent application Ser. No. 18/397,975.

### Two-Dimensional Search

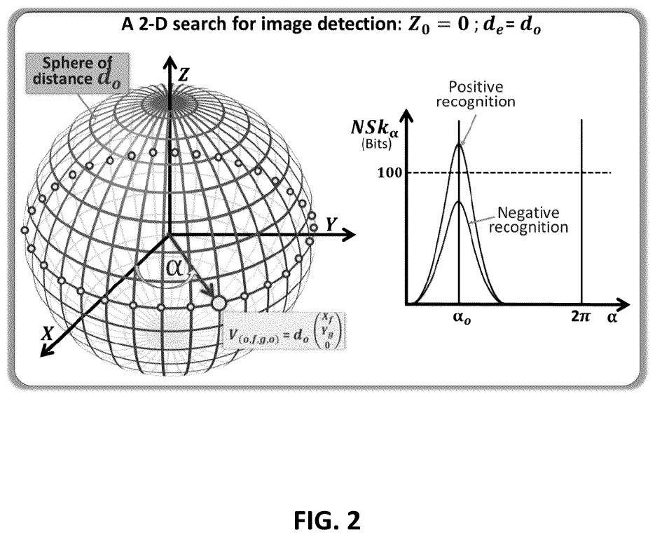

For the objects placed on a known surface, the search is 2-D along the X-Y axis. Assuming that the distance of observation is also known, the search is based on the rotation of the object, as defined by the angle α between the vector of orientation and the X-axis. The number of “1”s NSk_{α} is expected to be at its peak when α=α₀, as shown in FIG. 2. Positive and negative recognition is then quantified by NSkₐ=α₀ around α=α₀. The first objective is to find the optimal angle of observation α₀ of the object. The number of “1”s NSKα at the distance aa quantifies the levels of matching. The recognition cycle is judged as positive if NSKα is greater than 100 at its optimal position α₀.

### Three-Dimensional Search

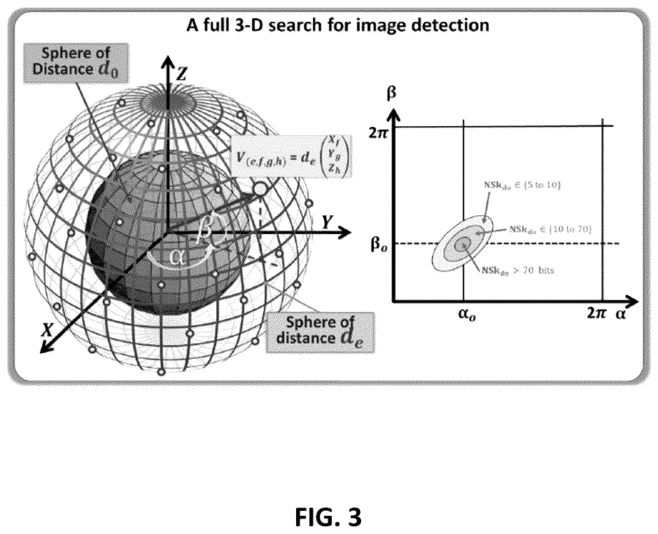

In the most general case, when both orientations and distances are unknown, a brute force search of the matching vector could be avoided by projecting the search into a 2-D space. This is shown in FIG. 3, as shown below in FIG. 3. The vectors of orientation are defined by the two angles α and β. Assuming that the distance d₀ is approximately known, the search is reduced to a 2-D search to find the two angles α₀ and β₀ which maximize the number of “1”s NSk_{αβ} of the key. The first objective is to find the angles of observation_{α0} and β₀ of the object. The number of “1”s NSKₑ at the distance de quantifies the levels of matching. With a linear search, the optimal distance of observation d₀ is computed. The recognition cycle is judged as positive if NSK₀ is greater than 100 at its optimal position d₀.

After uncovering α₀ and β₀ through this 2-D search, the dimension d₀ is computed through a linear search. This approach is much faster than a 3-D search. For example, assume that during enrollment cycle 25×25×25 different positions were captured, with the CRP mechanism measuring the 253 possible subsets of responses. The projection into a 2-D space will be about 25 times faster than the brute force search.

Finally, the determination of a positive or negative match follows again the computation of the number of “1”s NSk(d₀,α₀,β₀) at its peak. In the graph shown in the right of FIG. 3, exploring the number of “1”s around d₀, α₀ and β₀ is shown in blue. The number of “1”s is high. Further away from α₀ and β₀, shown in green and yellow, the number of “1”s is lower.

Two enrollment protocols will now be described: a quick enrollment cycle where enrollment is performed using a single image, and a comprehensive enrollment cycle, where multiple images are used at enrollment.

Protocol with Quick Enrollment

### Enrollment Cycle

In this scheme, the enrollment cycle is relatively short because only one image is generated from the object, resulting in a single set of responses. Such an enrollment cycle is similar to those previously developed for image authentication in U.S. patent application Ser. No. 18/638,412, referenced and incorporated by reference above. The overall sequence for enrollment is described as follows:
1. Generate an image from the object;
   D₀=dₘᵢₙ is the distance selected to observe the object;
   The vector

$${V}_{0} = {D}_{0} ( \begin{matrix}1 \\ 0 \\ 0\end{matrix} )$$

is referred to as the “reference vector”;
2. Pick a randomly selected ephemeral key Sk₍ᵥ₀₎;
3. Encrypt the plain text T with Sk₍ᵥ₀₎ to get cipher text Cip₀=E(T; Sk₍ᵥ₀₎);
4. Pick a randomly selected challenge C;
5. Using challenge C, generate a set of 256 responses R₍ᵥ₀₎ (example: with Johnson-Lindenstrauss);
6. Filter the set of responses R₍ᵥ₀₎ with Sk₍ᵥ₀₎ to generate a subset of responses RS₍ᵥ₀₎;
7. Store the challenge C, the cipher text Cip₍ᵥ₀₎, and the subset of responses RS₍ᵥ₀₎;
8. Erase Sk₍ᵥ₀₎, the plain text T, and the full set of responses R₍ᵥ₀₎.

To reduce error rates, several images can be captured from the same object, all at orientations very close, but not identical to the one of vector Vo. This allows the masking of the challenge/response pairs that are creating errors. For example, the challenge C can generate 512 responses. The error rates among the several images are expected to differ for each response. Only the 256 responses with lower error rates are kept for future recognition cycles.

### Object Recognition Cycle

During the object recognition cycle, multiple images of the object are needed which could be located at a different distance and with a different orientation. From these images, several images can be generated with image processing methods or AI. The virtual images are aligned along a range of orientations at various distances from the object.

The challenge C and the challenge/response pair mechanism are applied to each of these images to generate full sets of responses. The matching of these full sets of responses with the subset of responses generated during enrollment allows the recovery of the ephemeral key if one of the images generated during the recognition cycle is similar to the image generated during enrollment. The protocol is described as follows:
1. The terminal device knows C, Cip₍ᵥ₀₎, and the subset of responses RS₍ᵥ₀₎;
2. Generate a set of P images from the object to recognize:
   The vectors

$$( \begin{matrix}{X}_{f} \\ {Y}_{g} \\ {Z}_{h}\end{matrix} )$$

have various orientations with

$${X}_{f}^{2} + {Y}_{g}^{2} + {Z}_{h}^{2} = 1 ;$$

f ∈ {−n; n}; g ∈ {−m; m}; h ∈ {0; l}; n, m, l are natural numbers;
The images are observed from distances

$${d}_{e} = {d}_{min} + \frac{e}{q} ( {d}_{max} - {d}_{min} ) ;$$

With e ∈ {0; q}; q is a natural number;
The range of observation of the object is from dₘₐₓ to dₘₐₓ;
The P images (P=2n×2m×1× q) are generated along the P vectors

$${V}_{( e , f , g , h )} = {d}_{e} ( \begin{matrix}{X}_{f} \\ {Y}_{g} \\ {Z}_{h}\end{matrix} ) ;$$

3. For each image and C, generate a set of 256 responses R_{(e,f,g,h)} (ex: with Johnson Lindenstrauss); 4. With RS₍ᵥ₀₎, filter the set of responses R_{(e,f,g,h)} to generate a set of keys Sk_{(e,f,g,h)};
5. For each key Sk_{(e,f,g,h)}, count NSk_{(e,f,g,h)} (i.e., the number of states of “1”);
6. Find the key Skₘₐₓ with the greatest NSk_{(e,f,g,h)};
   If the highest number of “1”s is below 100, then the image recognition is negative;
   Else, assume that Skₘₐₓ≈Skᵥ₀, decrypt T with Skₘₐₓ: T=D(Cip₀; Skₘₐₓ);
      If T is a clear plain text, then the image recognition is positive;
      Else, search the key at short hamming distance from S Skₘₐₓ that can decrypt T;
      The result of the search will end, positively or negatively, after a fixed time.

Some of the parameters suggested in the protocol described above, such as a number of responses at 256, or minimum expected number of “1”s at 100, are illustrative, non-limiting examples that produced good results in experimental work. Any predetermined threshold for the number or percentage of expected is (or more generally the number or percentage of expected first binary symbols) are usable and within the scope of the invention.

Protocol with a Comprehensive Enrollment

As done in the first protocol employing quick enrollment, an ephemeral key encrypts a plain text during enrollment cycle. With photogrammetry, AI, or other methods, a broad range of images is generated from the object with various orientations and distances. With the CRP mechanism, a subset of responses is generated for each image from the ephemeral key. During the recognition cycle, just one image is generated from the object; with the same challenge C, the image generates a complete set of responses. The authentication is positive when the set of responses allows the retrieval of the ephemeral key from one from the subsets of responses generated during enrollment.

### Enrollment Cycle

In this scheme, the enrollment cycle is relatively long because multiple sets of responses are generated from a broad range of images. This may be done with a single camera that changes angle with respect to the object, or with an array of cameras. Additionally, two cameras may be used to create a model of the object, which may then be mathematically rotated and scaled to produce different virtual views.

Using the ephemeral key, multiple subsets of responses are generated from the sets of responses and kept as references for the subsequent recognition cycles. The generation, from a single object, of a range of images having various orientations can be done with a known method. The protocol is as follows:
1. Generate a set of P images from the object;
   The set of vectors (X_{f}; Y_{g}; Zₕ) are pointing at various orientations:

$${X}_{f}^{2} + {Y}_{g}^{2} + {Z}_{h}^{2} = 1 ;$$

With f ∈{−n; n}; g ∈{−m; m}; h ∈ {0; 1}; n, m, l are natural numbers;
The images are observed from distances

$${d}_{e} = {d}_{min} + \frac{e}{q} ( {d}_{max} - {d}_{min} ) ;$$

With e ∈ {0; q}; q is a natural number;
The range of observation of the object is from dₘₐₓ to dₘₐₓ;
The P images (P=2n×2m×1×q) are generated along the P vectors

$${V}_{( e , f , g , h )} = {d}_{e} ( \begin{matrix}{X}_{f} \\ {Y}_{g} \\ {Z}_{h}\end{matrix} ) ;$$

2. Pick a randomly selected ephemeral key Sk₀;
3. Pick a randomly selected challenge C;
4. Encrypt the plain text T with Sk₀ to get cipher text Cip₀=E(T; Sk₀);
5. For each vector V_{(e,f,g,h)}:
   With C, generate a set of 256 responses R_{(e,f,g,h)} (ex: with Johnson-Lindenstrauss);
   Filter the set of responses with Sk₀ to generate a subset of responses RS_{(e,f,g,h)};
6. Store the challenge C, the cipher text Cip₀, and P subsets of responses RS_{(e,f,g,h)};
7. Erase Sk₀, the plain text T, and P full sets of responses R_{(e,f,g,h)}.

### Object Recognition Cycle

The recognition cycle is relatively brief compared with the first method because the terminal device does not need to generate several images from the object. With the same challenge C and CRP mechanism, the full set of responses is generated from the image. The matching of this set of responses with the various subsets of responses gathered during enrollment allows the recovery of the ephemeral key if the image is similar to one of the images generated during enrollment. The protocol is described as follows:
1. The terminal device knows C, Cip₀, and the P subsets of responses RS_{(e,f,g,h)};
2. From the observed image I, generate the full set of responses R₍ₗ₎ from C;
3. Generate the P keys Sk_{(e,f,g,h)} from R₍ₗ₎ and the subsets RS_{(e,f,g,h)};
4. Count NSk_{(e,f,g,h)} the number of states of “1” for all keys Sk_{(e,f,g,h)};
5. Find the key Skₘₐₓ with the greatest NSk_{(e,f,g,h)};
   If the highest NSk_{(e,f,g,h)} is below 100, then the image recognition is negative;
   Else, assume that Skₘₐₓ≈Sk₀, decrypt T with Skₘₐₓ: T=D(Cip₀; Skₘₐₓ);
   If T is a clear plain text, then image recognition is positive;
      Else, search a key at short hamming distance from Skₘₐₓ that can decrypt T;
      The result of the search will end, positively or negatively after a fixed time.

### Simplification of the Recognition Cycle

If during the recognition cycle, the terminal device is equipped with the tools needed to find the distance dₑ₀ and the vector orientating the object

$$( \begin{matrix}{X}_{f 0} \\ {Y}_{g 0} \\ {Z}_{h 0}\end{matrix} ) ,$$

the number of possible responses is reduced to the single subset of responses RS_{(e0,f0,g0,h0)}. For example, if the object to recognize is a person, the recognition of the position of the two retina allows the generation of

$$V {(}_{e 0 , f 0 , g 0 , h 0} ) = {d}_{e 0} ( \begin{matrix}{X}_{f 0} \\ {Y}_{g 0} \\ {Z}_{h 0}\end{matrix} ) .$$

This will also be the case when the objects to recognize are buildings, vehicles, or equipment. The image recognition schemes presented here can be combined with other generic recognition methods while keeping the terminal device “template-less”. The loss to the opponent of the terminal device will keep secret the objective of the mission and accelerate the search.
Combination of the New Scheme with Other Image Detection Schemes

There are diverse methodologies and frameworks for image detection, such as Open Computer Vision Library (OpenCV) and You Only Look Once (YOLO). OpenCV, an expansive open-source library renowned for its applications in computer vision, machine learning, and image processing, has become an essential part of contemporary systems, assuming a pivotal role in real-time operations. Its comprehensive range of functions enables the efficient analysis of images and videos, enabling the detection of objects, faces, and human handwriting. YOLO, on the other hand, represents a widely acclaimed object detection model celebrated for its exceptional speed and unwavering accuracy. Developed by Joseph Redmon in 2016, this innovative model has continuously evolved, embracing various iterations to enhance its capabilities. YOLO utilizes a deep neural network to identify and localize objects within an image. The primary goal of YOLO is to predict bounding boxes and class probabilities for each object present in the input image. With its outstanding performance, YOLO has demonstrated remarkable results in object detection and localization across diverse datasets. The YOLO algorithm has been also extended to real-time object detection applications, making it a widely favored option for tasks involving object detection in video streams and robotics applications.

The fast development of image detection methods such as OpenCV and YOLO facilitate the proposed scheme in terms of detecting images and their necessary features. For instance, OpenCV is used to extract fingerprint features, then these features will be used as input of the new scheme to create challenge-response pairs (CRPs). OpenCV is also applied in detecting faces and biomedical images. that YOLO can detect multiple images from input video files and extract face image benchmarks. These benchmarks are then combined with our new scheme to generate CRPs for further authentication.

### Additional Applications in Biometry

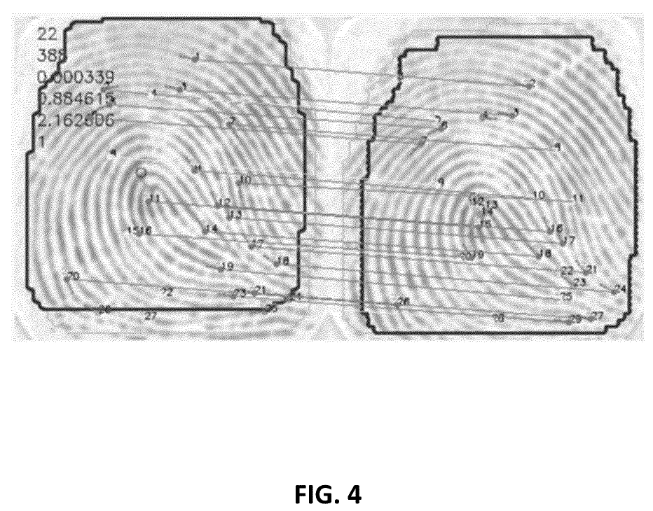

The new scheme seamlessly integrates with established image recognition methods, facilitating a wide array of authentication applications, including biometric authentication processes that leverage facial recognition, fingerprint scanning, and iris recognition. This integration significantly enhances the scheme's authentication capabilities, ensuring robust and secure verification processes for diverse users and applications. For example, consider a fingerprint authentication system, the proposed scheme will extract only fingerprint's features and generate CRPs for further authentication without storing fingerprint data. Similarly, the benchmarks of face images extracted by existing image detection techniques will be used to create CPRs for the future authentication. FIG. 4 illustrates the fingerprint authentication process using fingerprint features only.

### Key Generation for Post-Quantum Cryptography

Quantum computing poses a significant threat to conventional security systems that rely on classical encryption algorithms. Many encryption methods currently in use, such as elliptic curve cryptography (ECC) and Rivest-Shamir-Adleman (RSA), are vulnerable to attack by quantum computers. Notably, Shor's algorithm can efficiently crack ECC and RSA in polynomial time on a quantum computer.

Therefore, a critical challenge in the age of quantum computing is to develop new encryption and security mechanisms that are resistant to quantum attacks. In 2016, the National Institute of Standards and Technology (NIST) initiated a process to solicit, evaluate, and standardize public-key cryptographic algorithms that can withstand quantum attacks. Among the finalists in the third round of the NIST post-quantum cryptography project, lattice-based algorithms such as CRYSTALS-Kyber and CRYSTALS-Dilithium emerge as leading contenders for standardization.

### Authentication Processes

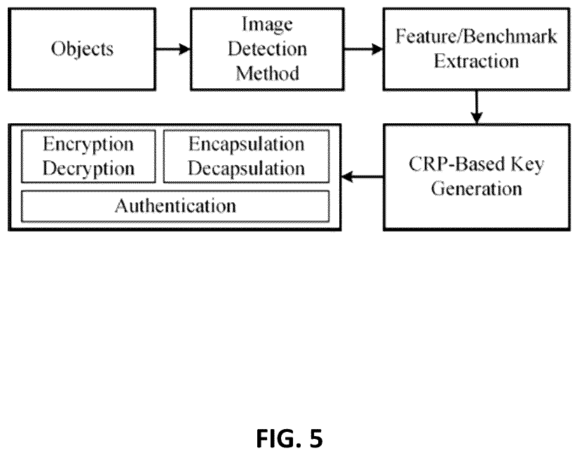

One of the popular methods to generate key pairs, including public and private keys, is to generate the keys from a certain distribution, for example, a Gaussian distribution, uniform distribution, or binomial distribution. However, these distributions have specific characteristics for the same set of parameters, which may introduce security issues if the set of parameters is leaked. The newly developed CRP scheme enables the generation of keys using special features and benchmarks of objects such as biometric images without storing object information. These keys vary across different objects and angles, providing enhanced security and variability. FIG. 5 presents a potential application of the new CRP mechanism in generating keys for encryption, decryption, encapsulation, decapsulation, and authentication processes.

The described features, advantages, and characteristics may be combined in any suitable manner in one or more embodiments. One skilled in the relevant art will recognize that the circuit may be practiced without one or more of the specific features or advantages of a particular embodiment. In other instances, additional features and advantages may be recognized in certain embodiments that may not be present in all embodiments.

Reference throughout this specification to “one embodiment,” “an embodiment,” or similar language means that a particular feature, structure, or characteristic described in connection with the embodiment is included in at least one embodiment. Thus, appearances of the phrase “in one embodiment,” “in an embodiment,” and similar language throughout this specification may, but do not necessarily, all refer to the same embodiment.

The invention claimed is:

1. A method of recognizing a biological object, comprising:
executing an enrollment procedure at a first computing device comprising:
generating a seed;
deriving, from the seed, an ordered sequence of n challenges specifying measurement instructions for a biometric print;
making an enrollment biometric print of a biological object, and measuring the enrollment biometric print in accordance with the ordered sequence of n challenges resulting in an ordered sequence of n enrollment responses;
generating a binary key K;
filtering the ordered sequence of n enrollment responses with the binary key K by selecting responses in the ordered sequence of n enrollment responses having the same positions in the ordered sequence of n enrollment responses as first binary symbols in the binary key K resulting in an ordered subset of m enrollment responses,
storing the seed, the ordered subset of m enrollment responses, and indicia of the binary key K;
executing a recognition procedure comprising:
deriving, from the seed, the ordered sequence of n challenges;
making a set of a recognition biometric prints of the biological object, and measuring a plurality of biometric prints in the set accordance with the ordered sequence of n challenges, resulting in a plurality of ordered sequences of n recognition responses;
generating a plurality of candidate binary keys by, for each of the plurality of ordered sequences of n recognition responses, comparing each response in each ordered sequence of n recognition responses to each response in the ordered subset of m enrollment responses, and for matches, assigning a first binary value to a candidate key in the position of the recognition response that matches the enrollment response, and assigning a second binary value for all other positions;
selecting a candidate binary key, and comparing indicia of the selected candidate binary key with the indicia of the binary key K to determine recognition of the object.

2. The method of claim 1, wherein the indicia of the binary key K comprises a digital file encrypted with binary key K, and comparing indicia of the selected candidate binary key with the indicia of the binary key K comprises using the selected candidate binary key to decrypt the file.

3. The method of claim 1, wherein selecting a candidate binary key comprises counting a number of first binary symbols assigned to each of the plurality of candidate binary keys and selecting the candidate binary key that has the most of the first binary symbols.

4. The method of claim 1, wherein selecting a candidate binary key comprises counting a number of first binary symbols assigned to each of the plurality of candidate binary keys and selecting a candidate binary key that has a number of first binary symbols above a predetermined threshold.

5. The method of claim 1, wherein the first binary symbol is a 1 and the second binary symbol is a 0.

6. The method of claim 1, wherein generating the seed comprises generating the seed with a random number generator.

7. The method of claim 1, wherein the biological object is one of a finger, palm, iris, or retina.

8. The method of claim 1, wherein the biological object is a human face.

9. The method of claim 8, wherein the ordered sequence of n challenges specifying measurement instructions for a biometric print specify instructions for measuring a distance from one or more points in a coordinate space to one or more facial landmarks.

10. The method of claim 1, further comprising excluding challenges from the set ordered sequence of n challenges on the basis of determining that certain challenges produce inconsistent responses or collisions after repeated measurements with those challenges.

11. The method of claim 1, wherein the enrollment process further comprises deleting the challenges and the biometric print.

12. The method of claim 1, wherein the first computing device executes the recognition process.

13. The method of claim 1, wherein a second computing device executes the recognition process after receiving the seed, the ordered sequence of n responses, and the indicia of the binary key K from the first computing device.

14. A method of recognizing a biological object, comprising:
executing an enrollment procedure at a first computing device comprising:
generating a seed;
deriving, from the seed, an ordered sequence of n challenges specifying measurement instructions for a biometric print;
making a plurality of enrollment biometric prints of a biological object under a plurality of measurement conditions, and measuring each of the plurality of biometric prints in accordance with the ordered sequence of n challenges resulting in a set of ordered sequences of n enrollment responses;
generating a binary key K;
filtering each of the ordered sequences of n enrollment responses with the binary key K by selecting responses in each ordered sequence of n enrollment responses having the same positions in the ordered sequence of n enrollment responses as first binary symbols in the binary key K resulting in a plurality of ordered subsets of m enrollment responses,
storing the seed, the plurality of ordered subsets of m enrollment responses, and indicia of the binary key K;
executing a recognition procedure comprising:
deriving, from the seed, the ordered sequence of n challenges;
making a recognition biometric print of the biological object, and measuring the biometric print in accordance with the ordered sequence of n challenges, resulting in an of ordered sequence of n recognition responses;
generating a plurality of candidate binary keys by, for each of the plurality of ordered sequences of m enrollment responses, comparing each response to each response in the ordered sequence of n recognition responses, and for matches, assigning a first binary value to a candidate key in the position of the recognition response that matches the enrollment response, and assigning a second binary value for all other positions;
selecting a candidate binary key, and comparing indicia of the selected candidate binary key with the indicia of the binary key K to determine recognition of the object.

15. The method of claim 13, wherein the indicia of the binary key K comprises a digital file encrypted with binary key K, and comparing indicia of the selected candidate binary key with the indicia of the binary key K comprises using the selected candidate binary key to decrypt the file.

16. The method of claim 13, wherein selecting a candidate binary key comprises counting a number of first binary symbols assigned to each of the plurality of candidate binary keys and selecting the candidate binary key that has the most of the first binary symbols.

17. The method of claim 13, wherein selecting a candidate binary key comprises counting a number of first binary symbols assigned to each of the plurality of candidate binary keys and selecting a candidate binary key that has a number of first binary symbols above a predetermined threshold.

18. The method of claim 13, wherein the enrollment process further comprises deleting the challenges and the biometric prints.

19. The method of claim 13, wherein the first computing device executes the recognition process.

20. The method of claim 13, wherein a second computing device executes the recognition process after receiving the seed, the plurality of ordered sequences of n responses, and the indicia of the binary key K from the first computing device.
